(19) United States
(12) Patent Application Publication
(10) Pub. No.: US 2019/0118322 A1
(43) Pub. Date: Apr. 25, 2019

(54) SELF-DUST SUCTION MECHANISM SUITABLE FOR ELECTRIC POWER TOOLS

(71) Applicant: YONGKANG CONGZHEN TOOLS CO., LTD, Jinhua (CN)

(72) Inventors: Mincan Yu, Shanghai (CN); Hesheng Wu, Jiujiang (CN)

(73) Assignee: YONGKANG CONGZHEN TOOLS CO.,LTD, Jinhua (CN)

(21) Appl. No.: 16/167,262

(22) Filed: Oct. 22, 2018

(30) Foreign Application Priority Data
Oct. 23, 2017 (CN) 201721370570.5

(51) Int. Cl. B23Q 11/00; F04D 29/053; F04D 29/056; F04D 29/22; F04D 29/42

(52) U.S. Cl. CPC B23Q 11/0046; F04D 29/053; F04D 29/4233; F04D 29/22; F04D 29/056

(57) ABSTRACT

This invention relates to the technical field of electric power tools, and in particular, relates to a self-dust suction mechanism suitable for various electric power tools. The self-dust suction mechanism is mounted between an operating end of the electric power tool and a motor output end of the electric power tool. The self-dust suction mechanism comprises: an upper cover, a volute a, a dust suction fan blade, a volute b, a stator assembly and a housing; wherein the stator assembly is internally provided with an armature assembly, the armature assembly being internally provided with an armature shaft, the armature shaft passing though the volute b, the dust suction fan blade and the volute a and being connected to an output shaft, an extension end of the upper cover and the volute a is provided with a plurality of dust suction inlets.

### TECHNICAL FIELD

This invention relates to the technical field of electric power tools, and in particular, relates to a self-dust suction mechanism suitable for electric power tools.

### BACKGROUND

When more and more attention is placed to environment protection nowadays, people are more and more concerning about the self-dust suction function of the electric power tools which produce dusts during operating. In China, many manufacturing enterprises are developing high efficiency self-dust suction mechanisms that are economic, reliable and practical. At present, conventional self-dust suction devices are mainly practiced as follows: (1) adding a deduster or a dust suction motor on the side of the original electric power tool; (2) adding a dust suction device at the tail of the original electric power tool; (3) adding a dust suction device on the side of the original tool; and (4) separating the motor from the operating end of the original tool, and then adding a dust suction device at the front end of the motor and driving the working mechanism by using a belt. These self-dust suction mechanisms, although they all achieve the self-dust suction function, may be subject to a common problem: the volume of the original tool is increased, the structure is not compact but complicated, and the cost is high. A more important defect lies in that these self-dust suction mechanisms are only suitable for movable electric power tools, but fail to accommodate the dust suction needs in handheld electric power tools having a small volume.

In conclusion, to solve the problem in the prior art, it is urgently desired to provide a self-dust suction mechanism suitable for various electric power tools, which may be mounted between a motor output end of the electric power tool and an operating end of the electric power tool, achieve a high dust suction efficiency, have a wide application scope and solve the problem in the prior art.

### SUMMARY

This invention provides a self-dust suction mechanism suitable for various electric power tools. The self-dust suction mechanism may be mounted between a motor output end of the electric power tool and an operating end of the electric power tool, achieves a high dust suction efficiency, has a wide application scope and solves the problem in the prior art.

To solve the above technical problem, this invention employs the following technical solution:

A self-dust suction mechanism suitable for various electric power tools is provided. The self-dust suction mechanism is mounted between an operating end of the electric power tool and a motor output end of the electric power tool. The self-dust suction mechanism sequentially comprises from top to bottom: an upper cover, a volute a, a dust suction fan blade, a volute b, a stator assembly and a housing; wherein the stator assembly is internally provided with an armature assembly, the armature assembly being internally provided with an armature shaft, the armature shaft passing though the volute b, the dust suction fan blade and the volute a and being connected to an output shaft, an extension end of the upper cover and the volute a is provided with a plurality of dust suction inlets, and an extension end of the volute a and the volute b is provided with a dust outlet.

Further, a wind blocking ring is arranged between the volute b and the stator assembly.

Further, a motor cooling fan is arranged between the wind blocking ring and the volute b.

Further, the dust suction fan blade is arranged on one side of the volute b and configured to cool an air suction inlet of the motor.

Further, the housing is provided with a housing rear cover, and the stator assembly, the housing and the housing rear cover are connected to each other via a bolt.

Further, the armature shaft and the output shaft are a single shaft or two independent shafts.

Further, torque transmission connection is achieved between the armature shaft and the output shaft which are independent shafts by virtue of shaft connection via a straight slot or double bearings.

This invention has the following advantages and achieves the following beneficial effects:

The self-dust suction mechanism suitable for various electric power tools according to this invention is mounted between the operating end of the electric power tool and the motor output end of the electric power tool, which reduces the volume of the self-dust suction electric power tool, and has a low cost and a high dust suction efficiency, and a compact structure. The dust suction fan blade and the motor cooling fan may be independently used, or the motor cooling fan may not be provided and the motor is cooled by using a volute dust suction fan blade. In this structure, a plurality of dust inlets and one dust outlet are designed, and the volute fan is responsible for cooling the motor, thereby addressing the problem that the motor output shaft is elongated due to embedment of the volute. By connecting the armature shaft and the output shaft by virtue of shaft connection via a straight slot or double bearings, the difficulty in assembling the volute to the motor is reduced, and a method of embedding the volute between the motor and the operating end is developed. The self-dust suction mechanism according to this invention is suitable for table saws, multifunctional saws, floor saws, movable electric power tools, miter saws, double miter rod saws, tile cutter, and handheld electric power tools for dedusting.

### BRIEF DESCRIPTION OF THE DRAWINGS

To describe embodiments of this invention or the technical solution in the related art, hereinafter, drawings that are to be referred for description of the embodiments or the related art are briefly described. Apparently, the drawings described hereinafter merely illustrate some embodiments of this invention. Persons of ordinary skill in the art may also derive other drawings based on the drawings described herein without any creative effort.

FIG. 1 is an exploded view of double fans in a self-dust suction mechanism suitable for various electric power tools according to this invention;

FIG. 2 is an exploded view of a single fan in the self-dust suction mechanism suitable for various electric power tools according to this invention;

FIG. 3 is a schematic structural view of a volute a in the self-dust suction mechanism suitable for various electric power tools according to this invention;

FIG. 4 is a sectional view of the single fan in the self-dust suction mechanism suitable for various electric power tools according to this invention;

FIG. 5 is a sectional view of the double fans in the self-dust suction mechanism suitable for various electric power tools according to this invention; and

FIG. 6 is a schematic connection view illustrating connection between an armature shaft and an output shaft in the self-dust suction mechanism suitable for various electric power tools by virtue of shaft connection via a straight slot or double bearings according to this invention.

Reference numerals and denotations thereof: 1—upper cover, 2—gear, 3—output shaft, 4—volute a, 5—dust suction fan blade, 6—volute b, 7—wind blocking ring, 8—armature assembly, 9—stator assembly, 10—housing, 11—housing rear cover, 12—motor cooling fan, 13—dust suction inlet, 14—dust outlet, and 15—armature shaft.

### DETAILED DESCRIPTION

This invention is further described with reference to and the attached drawings and specific embodiments. It should be noted herein that description of these embodiments is intended to help understanding of this invention instead of construing any limitation to this invention. In addition, technical features involved in various embodiments of this invention described hereinafter may be combined as long as these technical features are not in conflict.

### Embodiment 1

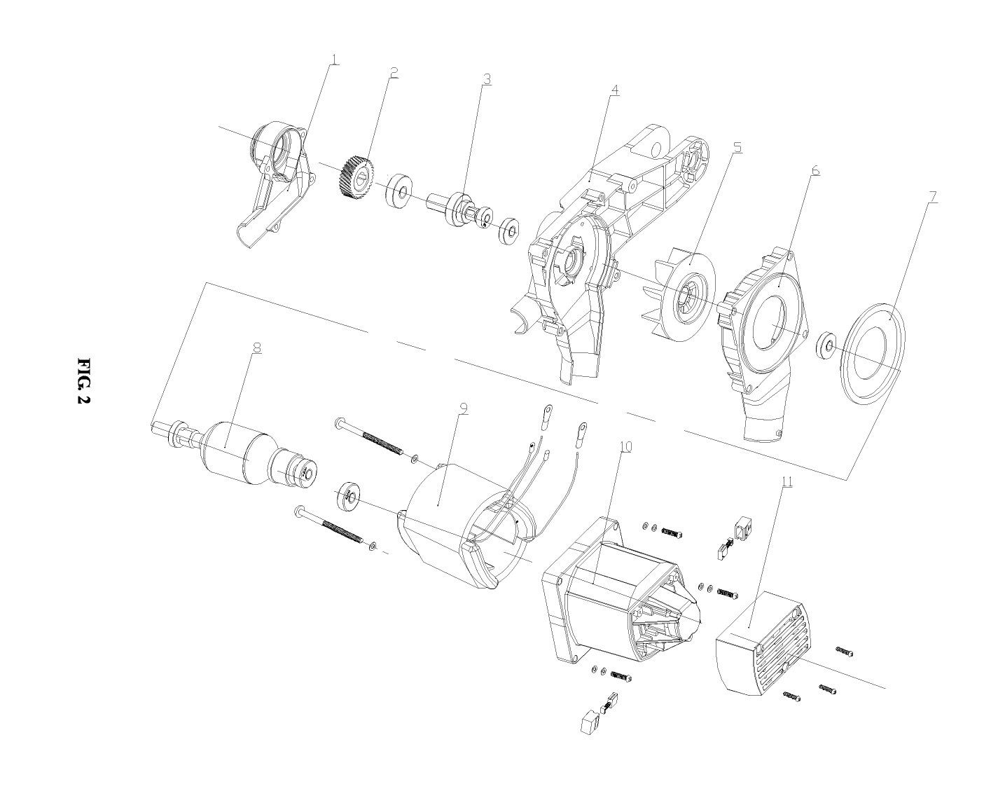

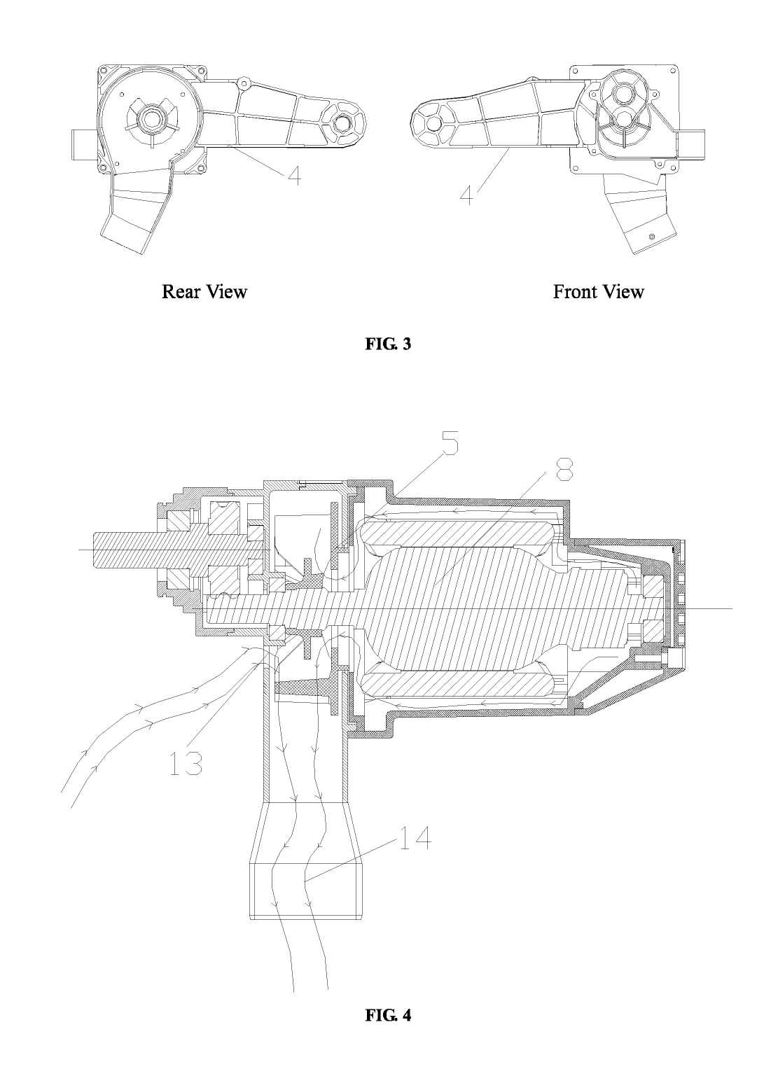

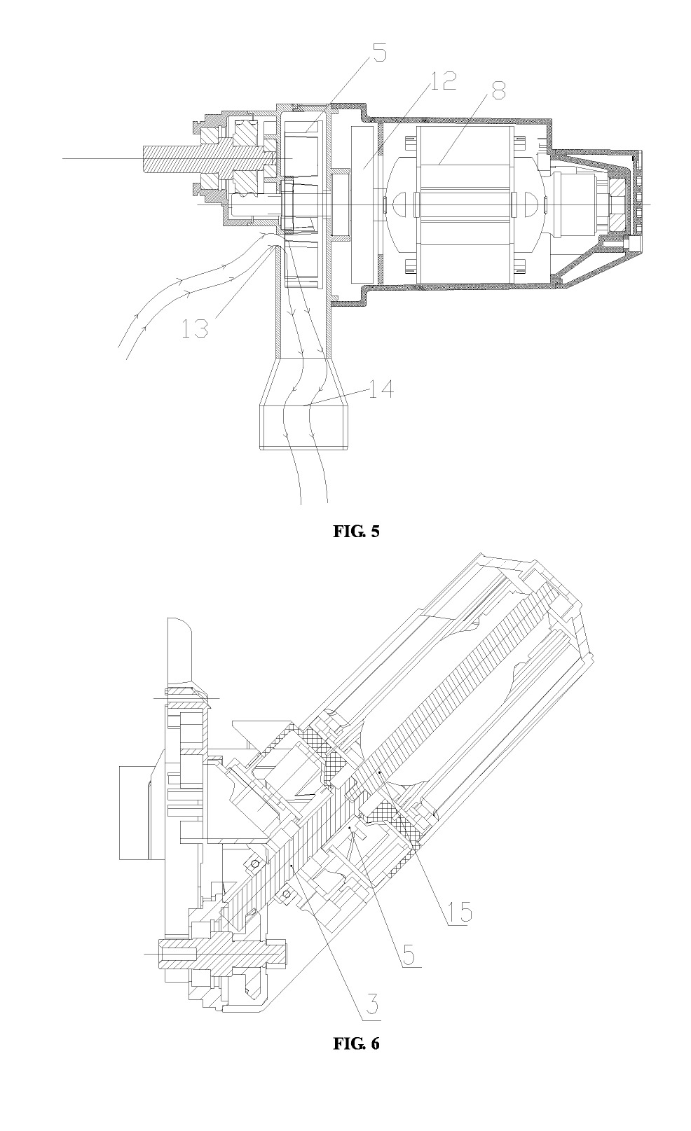

Referring to FIG. 2, FIG. 3, FIG. 4 and FIG. 6, an exploded view of a single fan, a schematic structural view of a volute b and a sectional view of the single fan in the self-dust suction mechanism suitable for various electric power tools according to this invention are illustrated. A self-dust suction mechanism suitable for various electric power tools is provided. The self-dust suction mechanism is mounted between an operating end of the electric power tool and a motor output end of the electric power tool. The self-dust suction mechanism sequentially comprises from top to bottom: an upper cover 1, a volute a 4, a dust suction fan blade 5, a volute b 6, a stator assembly 9 and a housing 10; wherein the stator assembly 9 is internally provided with an armature assembly 8, the armature assembly 8 being internally provided with an armature shaft 15, the armature shaft 15 passing though the volute b 6, the dust suction fan blade 5 and the volute a 4 and being connected to an output shaft 3, an extension end of the upper cover 1 and the volute a 4 is provided with a plurality of dust suction inlets 13, and an extension end of the volute a 4 and the volute b 6 is provided with a dust outlet 14.

A wind blocking ring 7 is arranged between the volute b 6 and the stator assembly 9. The housing 10 is provided with a housing rear cover 11, and the stator assembly 9, the housing 10 and the housing rear cover 11 are connected to each other via a bolt. A gear 2 is connected to one end of the output shaft 3.

The dust suction fan blade 5 is arranged on one side of the volute b 6 and configured to cool an air suction inlet of the motor. The armature shaft 15 and the output shaft 3 may be a single shaft or two independent shafts. Torque transmission connection is achieved between the armature shaft 15 and the output shaft 3 which are independent shafts by virtue of shaft connection via a straight slot or double bearings.

### Embodiment 2

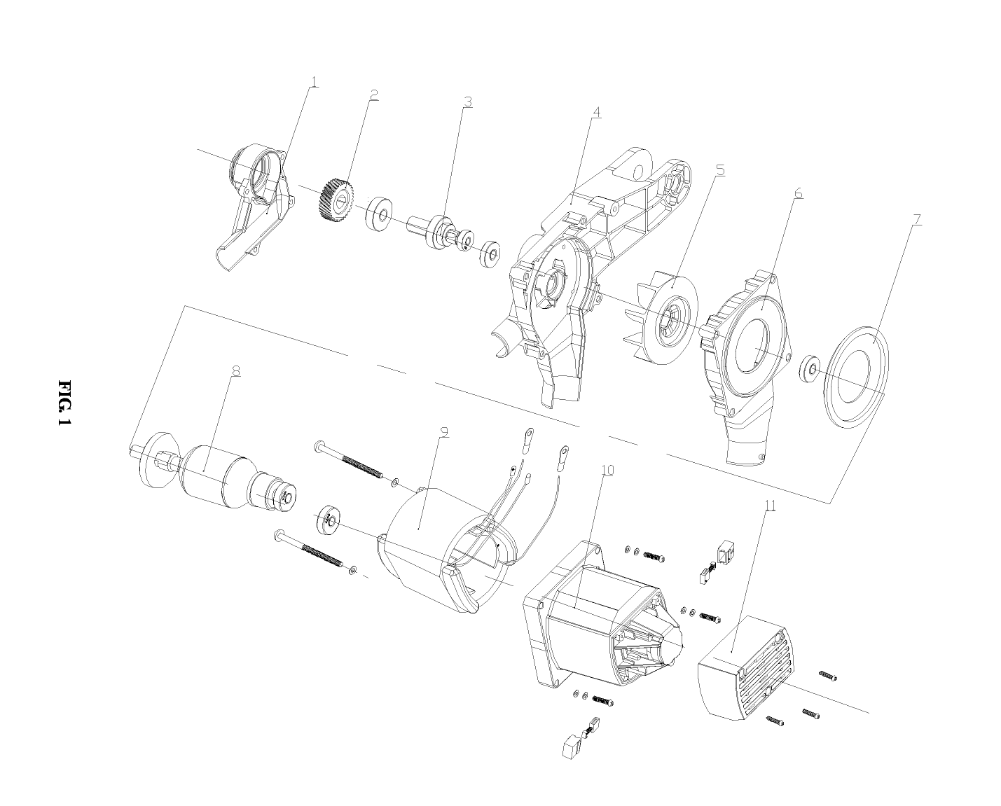

Referring to FIG. 1, FIG. 3, FIG. 5 and FIG. 6, an exploded view of double fans, a schematic structural view of a volute b and a sectional view of the double fans in the self-dust suction mechanism suitable for various electric power tools according to this invention are illustrated. A self-dust suction mechanism suitable for various electric power tools is provided. The self-dust suction mechanism is mounted between an operating end of the electric power tool and a motor output end of the electric power tool. The self-dust suction mechanism sequentially comprises from top to bottom: an upper cover 1, a volute a 4, a dust suction fan blade 5, a volute b 6, a stator assembly 9 and a housing 10; wherein the stator assembly 9 is internally provided with an armature assembly 8, the armature assembly 8 being internally provided with an armature shaft 15, the armature shaft 15 passing though the volute b 6, the dust suction fan blade 5 and the volute a 4 and being connected to an output shaft 3, an extension end of the upper cover 1 and the volute a 4 is provided with a plurality of dust suction inlets 13, and an extension end of the volute a 4 and the volute b 6 is provided with a dust outlet 14. A motor cooling fan 12 is arranged between the wind blocking ring 7 and the stator assembly 9.

The wind blocking ring 7 is arranged between the volute b 6 and the volute b 6. The housing 10 is provided with a housing rear cover 11, and the stator assembly 9, the housing 10 and the housing rear cover 11 are connected to each other via a bolt. A gear 2 is connected to one end of the output shaft 3.

The dust suction fan blade 5 is arranged on one side of the volute b 6 and configured to cool an air suction inlet of the motor. The armature shaft 15 and the output shaft 3 may be a single shaft or two independent shafts. Torque transmission connection is achieved between the armature shaft 15 and the output shaft 3 which are independent shafts by virtue of shaft connection via a straight slot or double bearings.

The embodiments of this invention are described in detail with reference to the accompanying drawings. However, this invention is not limited to the embodiments described. For a person skilled in the art would derive various modifications, variations and replacements made to the embodiments without departing from the principle and spirit of this invention shall all fall within the protection scope of this invention.

What is to be claimed is:

1. A self-dust suction mechanism suitable for various electric power tools, the self-dust suction mechanism being mounted between an operating end of the electric power tool and a motor output end of the electric power tool, characterized in that the self-dust suction mechanism sequentially comprises from top to bottom: an upper cover, a volute a, a dust suction fan blade, a volute b, a stator assembly and a housing; wherein the stator assembly is internally provided with an armature assembly, the armature assembly being internally provided with an armature shaft, the armature shaft passing though the volute b, the dust suction fan blade and the volute a and being connected to an output shaft, an extension end of the upper cover and the volute a is provided with a plurality of dust suction inlets, and an extension end of the volute a and the volute b is provided with a dust outlet.

2. The self-dust suction mechanism suitable for various electric power tools according to claim 1, wherein a wind blocking ring is arranged between the volute b and the stator assembly.

3. The self-dust suction mechanism suitable for various electric power tools according to claim 2, wherein a motor cooling fan is arranged between the wind blocking ring and the volute b.

4. The self-dust suction mechanism suitable for various electric power tools according to claim 1, wherein the dust suction fan blade is arranged on one side of the volute b and configured to cool an air suction inlet of the motor.

5. The self-dust suction mechanism suitable for various electric power tools according to claim 1, wherein the housing is provided with a housing rear cover, and the stator assembly, the housing and the housing rear cover are connected to each other via a bolt.

6. The self-dust suction mechanism suitable for various electric power tools according claim 3, wherein the housing is provided with a housing rear cover, and the stator assembly, the housing and the housing rear cover are connected to each other via a bolt.

7. The self-dust suction mechanism suitable for various electric power tools according claim 1, wherein the armature shaft and the output shaft are a single shaft or two independent shafts.

8. The self-dust suction mechanism suitable for various electric power tools according claim 3, wherein the armature shaft and the output shaft are a single shaft or two independent shafts.

9. The self-dust suction mechanism suitable for various electric power tools according claim 7, wherein torque transmission connection is achieved between the armature shaft and the output shaft which are independent shafts by virtue of shaft connection via a straight slot or double bearings.

10. The self-dust suction mechanism suitable for various electric power tools according claim 8, wherein torque transmission connection is achieved between the armature shaft and the output shaft which are independent shafts by virtue of shaft connection via a straight slot or double bearings.
